(19) United States
(12) Patent Application Publication
(10) Pub. No.: US 2014/0218425 A1
(43) Pub. Date: Aug. 7, 2014

(54) Laser Output and Inkjet Printing Machine

(71) Applicant: GREAT COMPUTER CORPORATION, New Taipei City (TW)

(72) Inventors: Shih LIANG, New Taipei City (TW); Chen-Chien TSAI, New Taipei City (TW); Tsung-I CHEN, New Taipei City (TW)

(73) Assignee: GREAT COMPUTER CORPORATION, New Taipei City (TW)

(21) Appl. No.: 13/758,398

(22) Filed: Feb. 4, 2013

(51) Int. Cl. B41J 2/21; B41J 2/44

(52) U.S. Cl. CPC B41J 2/21; B41J 2/442
USPC 347/2

(57) ABSTRACT

A laser output and inkjet printing machine comprises a machine body, a working rail set, an inkjet module, a laser output module and a pivotal apparatus. A processing platform is disposed on the machine body for placing a workpiece. The working rail set is disposed on the machine body and is controlled by the machine body to displace above the processing platform. The inkjet module is used for jetting ink on the workpiece. The laser output module is used for engraving or cutting patterns on the workpiece. The pivotal apparatus is used for coupling or separating the laser output module and the inkjet module so that the inkjet module can be coupled to the laser output module through the pivotal apparatus.

### BACKGROUND OF THE INVENTION

1. Field of Invention

The present invention relates to a machine with a machine body on which cutting or engraving by laser as well as inkjet printing can be performed.

2. Related Art

Currently, the print output industry mainly includes laser engraving and cutting as well as inkjet printing. This is the fundamental principle of how a common laser processing machine works, a laser beam is guided to focus on a surface of a to-be-engraved object. Then, the focused laser beam is absorbed by the material and the material is gasified due to the sudden increase of temperature, and causing the object surface to depress. Or, the to-be-processed object surface is heated up and fused by the focused high energy laser beam, and the material is blown down and fused by high pressure gas at the same time to achieve the purpose of engraving or cutting. For inkjet printing, ink cartridges of different colors are used for jetting ink of different concentrations and colors on a same location in order to produce the color wanted to present. The quality can be the same as that of a photo so as to save the time and work for halftone color separations, and therefore it has the predominance in the competitive market.

However, products processed by laser engraving and cutting or inkjet printing can no longer satisfy the requirements of customers and the market trend. A to-be-processed workpiece surface can have high and low levels and three-dimensional effect by using laser engraving, but usually only grayscale colors can be presented (grayscale colors and the material of the to-be-processed workpiece are correlated). Even though inkjet printing can present various colors, it is impossible to achieve obvious high and low levels for the surface of the finished product after printing. Therefore, the commercial value of a product can be elevated and the product will become more popular with consumers only if the workpiece is processed by laser engraving and cutting as well as inkjet printing.

In conventional technologies and equipment, laser output and inkjet printing are processed by two separate machines, which will not only increase the manufacturing costs, but it will also reduce the work efficiency and make the manufacturing procedures more complicated.

### SUMMARY OF THE INVENTION

A primary objective of the present invention is to provide a laser output and inkjet printing machine with a simple design, low costs and high efficiency.

In order to achieve the above-mentioned objectives, a laser output and inkjet printing machine of the present invention comprises a machine body, a working rail set, an inkjet module, a laser output module and a pivotal apparatus. A processing platform is disposed on the machine body for placing a workpiece. The working rail set is disposed on the machine body and is controlled by the machine body to displace above the processing platform. The inkjet module is used for jetting ink on the workpiece. The laser output module is used for engraving or cutting patterns on the workpiece. The pivotal apparatus is used for coupling or separating the laser output module and the inkjet module so that the inkjet module can be coupled to the laser output module through the pivotal apparatus.

The laser output module is coupled on the working rail set and can be controlled by the machine body to displace transversely and longitudinally on the working rail set for engraving or cutting patterns on the workpiece. The inkjet module is coupled on the working rail set and can be coupled to the laser output module through the pivotal apparatus. The inkjet module is driven by the laser output module indirectly to displace transversely and longitudinally on the working rail set for printing ink on the workpiece.

The present invention will become more fully understood by reference to the following detailed description thereof when read in conjunction with the attached drawings.

### BRIEF DESCRIPTION OF THE DRAWINGS

FIG. 1 is a schematic view of a laser output and inkjet printing machine according to an embodiment of the disclosure.

### DETAILED DESCRIPTION OF THE INVENTION

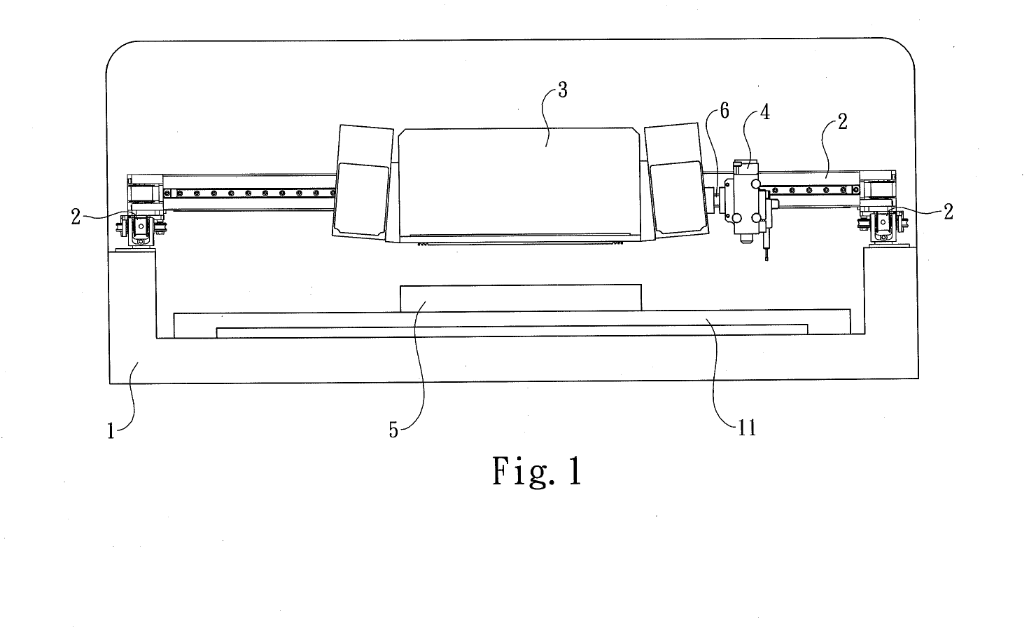

Please refer to FIG. 1, which is a schematic view of a laser output and inkjet printing machine according to an embodiment of the disclosure. The laser output and inkjet printing machine is composed of a machine body 1, a working rail set 2, an inkjet module 3, a laser output module 4 and a pivotal apparatus 6.

A processing platform 11 is disposed on the machine body 1 for placing a workpiece 5. The working rail set 2 is disposed on the machine body 1 and is disposed facing an upper side of the processing platform 11.

The laser output module 4 is coupled on the working rail set 2 and can be controlled by the machine body 1 to displace transversely and longitudinally above the processing platform 11 for engraving or cutting patterns on the workpiece 5.

The inkjet module 3 is coupled on the working rail set 2 and can be coupled to the laser output module 4 through the pivotal apparatus 6. The inkjet module 3 is driven by the laser output module 4 to displace transversely and longitudinally above the processing platform 11 for printing ink on the workpiece 5.

The pivotal apparatus 6 is an electromagnet or an actuated switch. Because the inkjet module 3 comprises a plurality of inkjet heads, ink cartridges and inkjet driving circuits, the weight of the inkjet module 3 is much heavier than that of the laser output module 4; and the speed of laser processing is far more faster than the jog speed of inkjet printing; during laser cutting or engraving, the laser output module 4 has to be separated from the inkjet module 3 and to operate independently in order to reduce the load and to increase the processing speed; during inkjet printing, the laser output module 4 has to be coupled with the inkjet module 3 in order to drive the inkjet module 3 not equipped with any driving device to perform printing. Therefore, the coupling between the laser output module 4 and the inkjet module 3 is achieved by using the detachable pivotal apparatus 6, so that the laser output module 4 and the inkjet module 3 can be separated during laser processing, and the laser output module 4 and the inkjet module 3 can be coupled together during inkjet printing.

Furthermore, the laser output module 4 is a CO₂ laser output module, the inkjet module 3 is an ink output device with eight sets of piezoelectric inkjet heads.

In implementation, after the workpiece 5 is placed on the processing platform 11, an operator can start to perform engraving or cutting, or inkjet printing sequentially. When engraving or cutting is performed, the laser output module 4 can be driven to operate. When inkjet printing is performed, the laser output module 4 is coupled to the inkjet module 3 through the pivotal apparatus 6, and the inkjet module 3 is driven indirectly to move and to perform inkjet printing. Therefore, the inkjet module 3 and the laser output module 4 can be set to displace at the same time based on the requirements. For example, during inkjet printing, the laser output module 4 can be coupled with the inkjet module 3 through the pivotal apparatus 6 in order to drive the inkjet module 3 to displace on the working rail set 2. Because the inkjet module 3 is loaded with the inkjet heads and ink cartridges, in order to reduce the load of the laser output module 4 during displacing, the inkjet module 3 and the laser output module 4 can be set to detach from each other. After the laser output is done, the laser output module 4 and the inkjet module 3 can be coupled together through the pivotal apparatus 6 for performing subsequent inkjet printing.

Thereby, by the design of the present invention, both laser output and inkjet printing functions can be equipped on the same machine for achieving laser engraving or cutting and inkjet printing in a single processing procedure respectively. Besides that the costs for purchasing laser output machine and inkjet printing machine separately can be saved, both the work and production efficiencies can be enhanced effectively.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

1. A laser output and inkjet printing machine, comprising:
a machine body, a processing platform being disposed on the machine body for placing a workpiece;
a working rail set disposed on the machine body and facing an upper side of the processing platform, and being controlled by the machine body;
an inkjet module coupled on the working rail set and being controlled by the machine body in order to jet ink on the workpiece;
a laser output module coupled on the working rail set to be located above the processing platform, and being controlled by the machine body to displace transversely and longitudinally on the working rail set for engraving or cutting patterns on the workpiece; and
a pivotal apparatus used for coupling or separating the laser output module and the inkjet module so that the inkjet module being coupled to the laser output module through the pivotal apparatus, the inkjet module being driven by the laser output module to displace on the working rail set.

2. The laser output and inkjet printing machine as claimed in claim 1, wherein the laser output module is a CO₂ laser output module.
